(19) United States
(12) Patent Application Publication
(10) Pub. No.: US 2026/0149734 A1
(43) Pub. Date: May 28, 2026

(54) METHOD AND SYSTEM FOR MONITORING A COMMUNICATIONS NETWORK ON BOARD AN AIRCRAFT

(71) Applicant: AIRBUS OPERATIONS SAS, Toulouse (FR)

(72) Inventors: Valentin KRETZSCHMAR, Toulouse (FR); Pierre-Julien CHAINE, Toulouse (FR)

(73) Assignee: AIRBUS OPERATIONS SAS, Toulouse (FR)

(21) Appl. No.: 19/400,905

(22) Filed: Nov. 25, 2025

(30) Foreign Application Priority Data
Nov. 27, 2024 (FR) 2413071

(51) Int. Cl. H04L 9/40; H04W 28/08

(52) U.S. Cl. CPC H04L 63/1441; H04W 28/0925

(57) ABSTRACT

A method for monitoring an onboard communications network of an aircraft including, for a data stream transmitted or received by a switch of the network, a traffic policing function (making it comply with a bandwidth limit) and a security function that obtains measurements of at least one parameter of the traffic; as a function of the measurements obtained, calculates a value of at least one bandwidth consumption parameter, participating in a definition of a measured profile of bandwidth consumption; compares the measured profile with a predetermined profile, by comparing the calculated value with a reference value; and in the case of verification of at least one difference criterion, performs at least one act for safeguarding the network. This allows an unusual profile (although remaining below the bandwidth limit) of bandwidth consumption to be detected, which may constitute a malicious act.

### TECHNICAL FIELD

The field of the invention is that of monitoring communications networks on board an aircraft.

### PRIOR ART

Aircraft generally comprise one or more onboard communications networks, provided to allow communications between onboard equipment, in particular onboard computers. In order to satisfy the requirements of the regulations with regard to certification of aircraft, an onboard communications network must be deterministic, in other words it must allow transmission of information from a transmitter device, subscribed to this communications network, to one or more receiver devices, also subscribed to this communications network, with a transmission time less than a predetermined time together with a guarantee of no loss of information across the network.

The standard ARINC 664 part 7 defines an onboard avionics communications network, of the deterministic switched Ethernet type, based on a full-duplex Ethernet technology. In such a network, which may for example correspond to an AFDX (registered trademark) (for “Avionics Full DupleX switched Ethernet”) communications network, each device subscribed to the communications network (also sometimes simply called “subscriber”) is connected to a switch of the network and the communications between the various devices (subscribers) take place via virtual links predefined during the definition and the configuration of the network. A virtual link is defined between a transmitter device and one or more receiver devices, via one or more switches of the network. Each virtual link follows a given route within the network. A bandwidth is allocated to each virtual link and the routing of the various virtual links of the network is implemented in such a manner that the sum of the bandwidths allocated to the virtual links going via the same physical connection does not exceed the bandwidth supported by the said physical connection. This is necessary in order to guarantee the determinism of the network. All the communications between equipment are defined in advance, by the definition of the virtual links, in order to allow a configuration of the switches. Each switch comprises a configuration table which is a function of the virtual links going via this switch.

The future avionics systems will need to face up to increasing threats with regard to security. In particular, the avionics communications network is a potentially important means of attacking the avionics systems because it is connected to multiple systems and to interfaces with other system areas and with communications infrastructures outside of the aircraft. For this reason, the technology currently used to monitor an avionics communications network comprises a “Traffic Policing Function” which contributes to the protection against certain types of threats. Indeed, the traffic policing function verifies that the number of frames and their size does not exceed a certain threshold (also called “bandwidth limit”), for example defined in a “Traffic Contract”. Thus, the standard ARINC 664 part 7 includes a traffic policing function, based on the byte or on the frame, and which follows the “Token Bucket Policy”.

The traffic policing function protects against attacks of the “Denial-Of-Service” type, which use a large number of requests in order to exceed the capacity of the receiver to process them, which leads to a failure. But it does not detect any attack whose traffic profile remains lower than the configured threshold (bandwidth limit). In other words, it verifies that the input traffic does not exceed the allocated bandwidth. It would however be desirable to be able to furthermore detect attacks such that the traffic remains within the allocated bandwidth.

Consequently, although the technology currently used for monitoring an onboard (avionics) communications network is satisfactory, there nevertheless exists a need for further improvement.

### DESCRIPTION OF THE INVENTION

A method is provided for monitoring an onboard communications network of an aircraft, the communications network being a deterministic switched Ethernet network using virtual links and comprising a set of subscribers and a set of switches, the method being implemented by a monitoring system comprising an electronic circuitry, the method comprising, for a data stream transmitted or received by a given switch, a traffic policing function configured to make it comply with a bandwidth limit for the said data stream. The method furthermore comprises, for the said data stream, a security function, configured to make it comply with a reference bandwidth consumption profile below the bandwidth limit, the security function comprising:
obtain measurements of at least one parameter of the said data stream;
as a function of the measurements obtained, calculate a value of at least one bandwidth consumption parameter, the calculated value participating in a definition of a measured bandwidth consumption profile;
compare the measured profile with the reference profile, by comparing the calculated value of the at least one bandwidth consumption parameter with a reference value defined in the reference profile; and
in the case of verification of at least one difference criterion, identified by the comparison, perform at least one act for safeguarding the communications network.

Thus, the solution provided allows a bandwidth consumption of traffic which remains below the bandwidth limit to be monitored, in order to detect any unusual behaviour which may constitute a malicious act. This allows the detection of and measures to be taken against attacks generated by the transmission of traffic remaining within the allocated bandwidth (in other words below the bandwidth limit).

According to one particular embodiment, the at least one parameter of the data stream, for which measurements are obtained, belongs to the group comprising: an average number of frames per second; an average number of bytes per second; a minimum data rate of the data stream; a maximum data rate of the data stream; and an average data rate of the data stream.

According to one particular embodiment, the at least one bandwidth consumption parameter belongs to the group comprising: at least one parameter relating to an envelope of the data stream; and at least one parameter relating to a periodicity of the data stream.

According to one particular embodiment, the at least one difference criterion belongs to the group comprising:
an overconsumption peak, defined by a number of frames or of bytes of the data stream, received or transmitted over a first time period, which is higher than a first high reference value;
a persistent overconsumption, defined by a number of frames or of bytes of the data stream, received or transmitted over a second time period longer than the first time period, which is higher than a second high reference value;
an under-consumption peak, defined by a number of frames or of bytes of the data stream, received or transmitted over a third time period, which is lower than a first low reference value;
a persistent under-consumption, defined by a number of frames or of bytes of the data stream, received or transmitted over a fourth time period longer than the third time period, which is lower than a second low reference value;
an average data rate of the data stream which is higher than an average reference data rate; and
a model of the data stream which shows at least one difference with a reference model, the model of the data stream being obtained by applying, at times of transmission or of receipt of frames of the data stream, a mathematical time/frequency conversion function, the reference model being obtained by applying, at times of transmission or of receipt of frames of a standard data stream, the said mathematical function.

According to one particular embodiment, the at least one safeguarding act belongs to the group comprising:
record a security event indicating the verification of the at least one difference criterion;
request the given switch to block a port of the given switch involved in transmitting or receiving the data stream;
request the given switch to block a virtual link involved in transmitting or receiving the data stream;
request the given switch re-route the data stream in order to record it;
warn the subscribers of the communications network so that they refuse the data stream; and
reduce a priority assigned to the data stream.

According to one particular embodiment, the data stream is transmitted or received by a given port of the given switch.

According to one particular embodiment, the data stream is transmitted or received via a given virtual link going via a given port of the given switch.

A computer programme product is also provided, comprising instructions leading to the execution, by a processor, of the method described hereinabove according to any one of its embodiments, when the said instructions are executed by the processor.

A storage medium is also provided, storing such instructions.

A system is also provided for monitoring an onboard communications network of an aircraft, the communications network being a deterministic switched Ethernet network using virtual links and comprising a set of subscribers and a set of switches, the monitoring system comprising an electronic circuitry configured for implementing, for a data stream transmitted or received by a given switch, a traffic policing function configured to make it comply with a bandwidth limit for the said data stream. The electronic circuitry is furthermore configured for implementing, for the said data stream, a security function, configured to make it comply with a reference of bandwidth consumption profile below the bandwidth limit, the security function comprising:
obtain measurements of at least one parameter of the said data stream;
as a function of the measurements obtained, calculate a value of at least one bandwidth consumption parameter, the calculated value participating in a definition of a measured profile of bandwidth consumption;
compare the measured profile with the reference profile, by comparing the calculated value of the at least one bandwidth consumption parameter with a reference value defined in the reference profile; and
in the case of verification of at least one difference criterion, identified by the comparison, perform at least one act for safeguarding the communications network.

An aircraft is also provided comprising an onboard communications network which is a deterministic switched Ethernet network using virtual links and comprising a set of subscribers and a set of switches. The aircraft comprises a monitoring system such as described hereinabove.

### BRIEF DESCRIPTION OF THE DRAWINGS

The features of the invention mentioned hereinabove, together with others, will become more clearly apparent upon reading the following description of at least one exemplary embodiment, the said description being presented in relation with the appended drawings, amongst which:

FIG. 1 illustrates schematically, as a side view, an aircraft equipped with a system for monitoring an onboard communications network;

FIG. 2 illustrates schematically the communications network and the monitoring system, in a first embodiment;

FIG. 3 illustrates schematically one example of a reference profile of bandwidth consumption below a bandwidth limit;

FIG. 4 illustrates schematically one example of a monitoring algorithm executed by the monitoring device in FIG. 2, in one embodiment;

FIG. 5 illustrates schematically one example of a hardware architecture configured for implementing the monitoring device in FIG. 2, in one embodiment;

FIG. 6 illustrates schematically the communications network and the monitoring system, in a second embodiment;

FIG. 7 illustrates schematically the communications network and the monitoring system, in a third embodiment; and

FIG. 8 illustrates schematically one example of a difference criterion.

### DETAILED DESCRIPTION OF EMBODIMENTS

The detailed description hereinafter is aimed at describing embodiments of the present invention in the context of an aircraft comprising an onboard communications network that needs to be monitored.

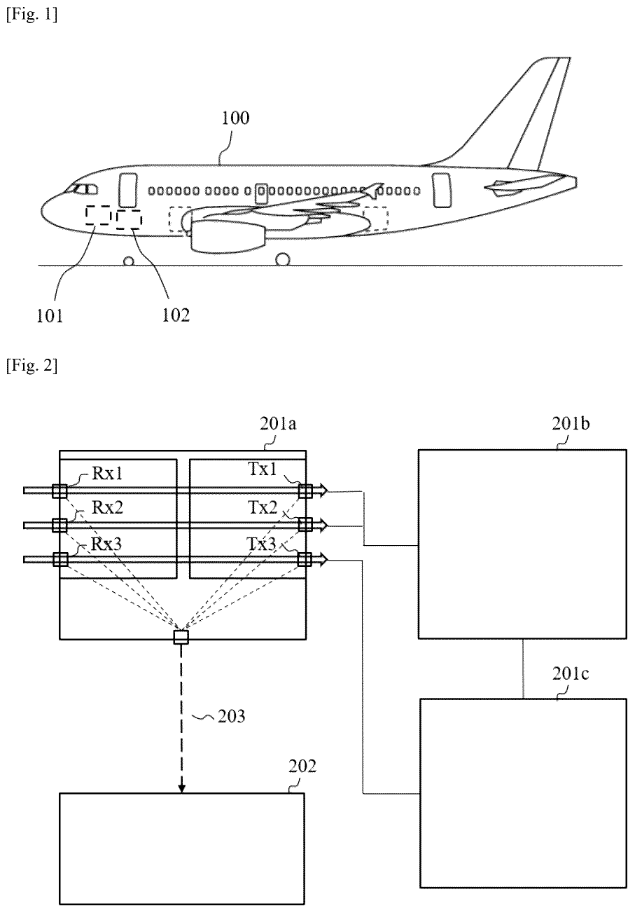

FIG. 1 illustrates schematically, as a side view, an aircraft 100 equipped with a communications network 101 and with a system 102 for monitoring this network 101. The communications network 101 is a deterministic switched Ethernet network, using virtual links (or VL) and comprising a set of subscribers and a set of switches. It for example conforms to the standard ARINC 664 part 7.

FIG. 2 illustrates schematically the communications network 101 and the monitoring system 102, in a first embodiment.

The communications network 101 comprises switches 201a, 201b and 201c. Each switch comprises input ports (also called “receiver communication ports”) and output ports (also called “transmission communication ports”). In the example illustrated in FIG. 2, the switch 201a comprises three input ports Rx1, Rx2 and Rx3 and three output ports Tx1, Tx2 and Tx3, the output ports Tx1 and Tx2 being connected to the switch 201b and the output port Tx3 being connected to the switch 201c. The communications between the various devices (subscribers) take place via predefined virtual links. A virtual link is defined between a transmitter device and one or more receiver devices, via one or more switches of the network. Each virtual link takes a given route within the network. Thus, one or more virtual links may go through each input or output port of a switch.

In the following part of the description, by way of example, the monitoring of a data stream transmitted or received by the switch 201a (also called in the following “monitored traffic”) is considered. In a first embodiment, the monitored traffic is a data stream received on one of the input ports (Rx1 to Rx3) or transmitted on one of the output ports (Tx1 to Tx3) of the switch 201a. In this first embodiment, a monitoring is therefore implemented on a given port. If several virtual links go through this given port (input or output port), the monitored traffic comprises several sub-streams each corresponding to virtual links. In a second embodiment, the monitored traffic is a data stream transmitted or received via a given virtual link going through a given port (input or output) of the switch 201a. In this second embodiment, a monitoring is therefore implemented on a given virtual link. This may be a given virtual link from amongst a plurality of virtual links going through this given port.

In order to carry out this monitoring of a data stream transmitted or received by the switch 201a (monitored traffic), the monitoring system 102 comprises a monitoring device 202, external to the switch 201a and connected to the latter via a link 203. In one embodiment, the monitoring device 202 also performs the monitoring of other data streams transmitted or received by the switch 201a. In one embodiment, the monitoring device 202 also performs the monitoring of the data streams transmitted or received by the other switches 201b and 201c. In one variant embodiment, each switch (from amongst the plurality of switches 201 a, 201b and 201c) is connected to a separate monitoring device, monitoring the data stream or data streams transmitted or received by this switch.

The monitoring device 202 comprises an electronic circuitry configured for implementing, for the monitored traffic:
a traffic policing function (conventional), configured to make the monitored traffic comply with a bandwidth limit; this traffic policing function implements for example the token bucket policy; and
a security function (according to the present invention), configured to make the monitored traffic comply with a reference profile (predetermined) of bandwidth consumption below the bandwidth limit. This security function is configured for detecting attacks generated by sending a stream remaining below the bandwidth limit, by detecting any unusual behaviour which may constitute a malicious act. The security function is furthermore configured to counter the attacks detected.

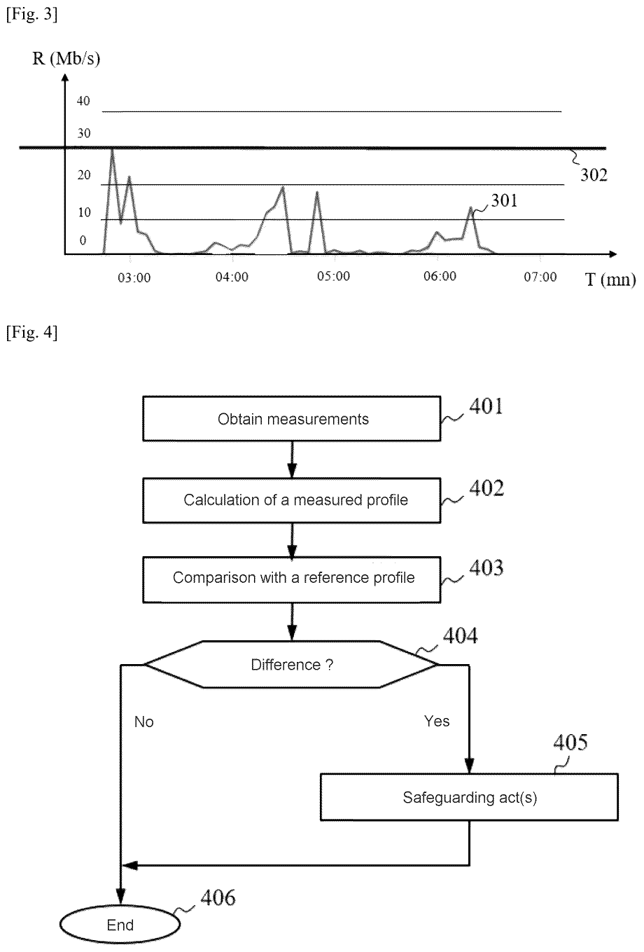

FIG. 3 illustrates schematically one example of such a reference profile of bandwidth consumption 301 below a bandwidth limit 302 (constant value here equal to 30 Mb/s). The reference profile takes the form of a curve 301 representing the variation of the data rate R (in Mb/s) as a function of time T (in min). The reference profile (also called “model”) corresponds to the standard state of the traffic and may for example be defined on the basis of the content of interface configuration documents (or ICD, which precisely define the data and their size to be sent on each stream) or by measurement on a representative test bench.

FIG. 4 illustrates schematically one example of a monitoring algorithm executed by the monitoring device 202, in one embodiment.

In a step 401, the monitoring device 202 obtains measurements of at least one parameter of the monitored traffic. In the example detailed above, this is a data stream transmitted or received on one of the ports (output or input, respectively) of the switch 201a, or else a data stream transmitted or received via a virtual link going through one of the ports (output or input, respectively) of the switch 201a.

The measurements are for example carried out in the switch in question (the one referenced 201a in the aforementioned example), over all the frames of the monitored traffic. In this case, the traffic policing function may be used as source for these measurements. The monitoring device 202 receives, via the link 203, the measurements carried out by the switch 201a. The measurements are for example periodically sent to the monitoring device 202, in the form of discrete measured values, in the form of pre-calculated average values or else in the form of a hashing of measurements indicating the state of the traffic over a predefined period.

In one embodiment, the measurements obtained relate to one or more of the following parameters:
an average number of frames per second (obtained for example from an average consumption of tokens supplied by the traffic policing function);
an average number of bytes per second (obtained for example from an average consumption quantity supplied by the traffic policing function);
a minimum data rate of the data stream (obtained for example from a minimum fill level of the token bucket supplied by the traffic policing function);
a maximum data rate of the monitored traffic (obtained for example from a maximum fill level of the token bucket supplied by the traffic policing function);
an average data rate of the monitored traffic (obtained for example from an average fill level of the token bucket supplied by the traffic policing function);
etc.

In a step 402, as a function of the measurements obtained, the monitoring device 202 calculates a value of at least one bandwidth consumption parameter. The value thus calculated participates in a definition of a measured profile of bandwidth consumption. In one embodiment, the monitoring device 202 calculates a value of at least one parameter relating to an envelope of the monitored traffic and/or a value of at least one parameter relating to a periodicity of the monitored traffic.

In a step 403, the monitoring device 202 compares the measured profile with the reference profile, by comparing, for each consumption parameter used, the calculated value with a reference value defined in the reference profile.

In a step 404, the monitoring device 202 determines, depending on the results of the comparison, whether a criterion (predetermined) of difference between the measured profile and the reference profile is verified, this criterion corresponding to the detection of an unusual behaviour which may constitute a malicious act. An appropriate uncertainty (number of violations over a given period, margin in the violation threshold, etc.) may be applied to the evaluation of the difference between the reference profile and the measured profile, in order to avoid false positive situations.

In one embodiment, the monitoring device 202 uses one or more of the following difference criteria (the first five items relate to a parameter relating to an envelope of the monitored traffic, whereas the sixth item relates to a parameter relating to a periodicity of the monitored traffic):
an overconsumption peak, defined by a number of frames or of bytes of the monitored traffic, received or transmitted over a first time period (short, for example 1 second), which is higher than a first high reference value;
a persistent overconsumption, defined by a number of frames or of bytes of the monitored traffic, received or transmitted over a second time period (long, for example 10 seconds) longer than the first time period, which is higher than a second high reference value;
an under-consumption peak, defined by a number of frames or of bytes of the monitored traffic, received or transmitted over a third time period, which is lower than a first low reference value;
a persistent under-consumption, defined by a number of frames or of bytes of the monitored traffic, received or transmitted over a fourth time period longer than the third time period, which is lower than a second low reference value;
an average data rate of the data stream which is higher than an average reference data rate; and
a model of the monitored traffic which has at least one difference with a reference model, the model of the monitored traffic being obtained by applying, at times of transmission or of receipt of frames of the monitored traffic, a mathematical time/frequency conversion function (Fourier transform for example), the reference model being obtained by applying, at times of transmission or of receipt of frames of a standard data stream (reference stream), the same mathematical function.

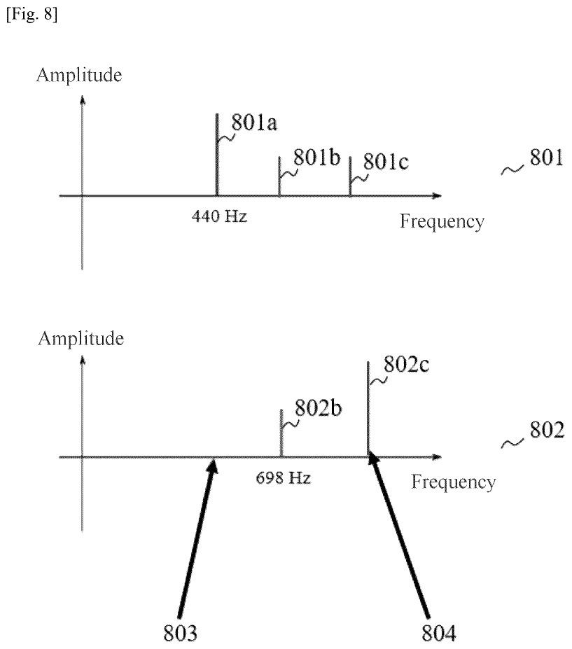

FIG. 8 illustrates schematically one example of a difference criterion according to the sixth item. The top part 801 of FIG. 8 shows the reference model, in other words here the result of the Fourier transform calculated from the times of transmission or of receipt of the frames of the standard stream, comprising three frequency peaks 801a, 801b and 801c. The lower part 802 of FIG. 8 shows the model of the monitored traffic, in other words here the result of the Fourier transform calculated from times of transmission or of receipt of the frames of the monitored traffic, comprising two pulses 802b and 802c. In the example in FIG. 8, the model of the monitored traffic exhibits two differences 803 and 804 with the reference model: on the one hand (difference 803) the absence of a pulse corresponding to the pulse 801a and, on the other (difference 804), the pulse 802c has an amplitude higher than that of the pulse 801c.

In the case of a positive response to the test of the step 404, the monitoring device 202 goes to the step 405, in which it performs at least one act for safeguarding the communications network so as to allow it to counter attacks generated by sending a data stream remaining below the bandwidth limit. It subsequently goes to the end step 406. In the case of a negative response to the test of the step 404, the monitoring device 202 goes directly to the end step 406.

In one embodiment, the monitoring device 202 performs one or more of the following safeguarding acts which allow the said malicious attacks to be countered:
record a safeguarding event indicating the verification of the at least one difference criterion (in other words the positive response to the test of the step 404);
request the given switch 201a (by sending a request) to block the port involved in transmitting or receiving the monitored traffic;
request the given switch 201a (by sending a request) to block the virtual link involved in transmitting or receiving the monitored traffic;
request the given switch 201a (by sending a request) to re-route the monitored traffic for it to be recorded;
warn the subscribers of the network 101 (by sending a request) so that they refuse the monitored traffic;
request the given switch 201a (by sending a request) to reduce a priority assigned to the monitored traffic;
etc.

FIG. 5 illustrates schematically one example of a hardware architecture (platform) 500 configured for implementing the monitoring device 202 in FIG. 2, in one embodiment.

The hardware architecture 500 comprises, connected via a communications bus 510: a processor or CPU (Central Processing Unit) 501; a volatile memory RAM (Random Access Memory) 502; a non-volatile memory ROM (Read Only Memory) 503, for example a Flash memory; a data storage device, such as a hard disk HDD (Hard Disk Drive), or a storage medium reader, such as an SD (Secure Digital) card reader 504; at least one communications interface 505 allowing the monitoring device 202 to interact with other elements, notably the switch 201a.

The processor 501 is capable of executing instructions loaded into the RAM 502 from the ROM 503, from an external memory (not shown), from a storage medium, such as an SD card, or from a communications network (not shown). When the monitoring device 202 is powered up, the processor 501 is capable of reading instructions from the RAM 502 and of executing them. These instructions form a computer programme causing the implementation, by the processor 501, of the behaviours, steps and algorithm described here.

All or part of the behaviours, steps and algorithm described here may thus be implemented in the form of software by execution of a set of instructions by a programmable machine, such as a DSP (Digital Signal Processor) or a microcontroller, or be implemented in the form of hardware by a machine or a dedicated component (or “chip”) or a set of components (or “chipset”), such as an FPGA (Field-Programmable Gate Array) or an ASIC (Application-Specific Integrated Circuit). Generally speaking, the monitoring device 202 comprises electronic circuitry arranged and configured for implementing the behaviours, steps and algorithms described here.

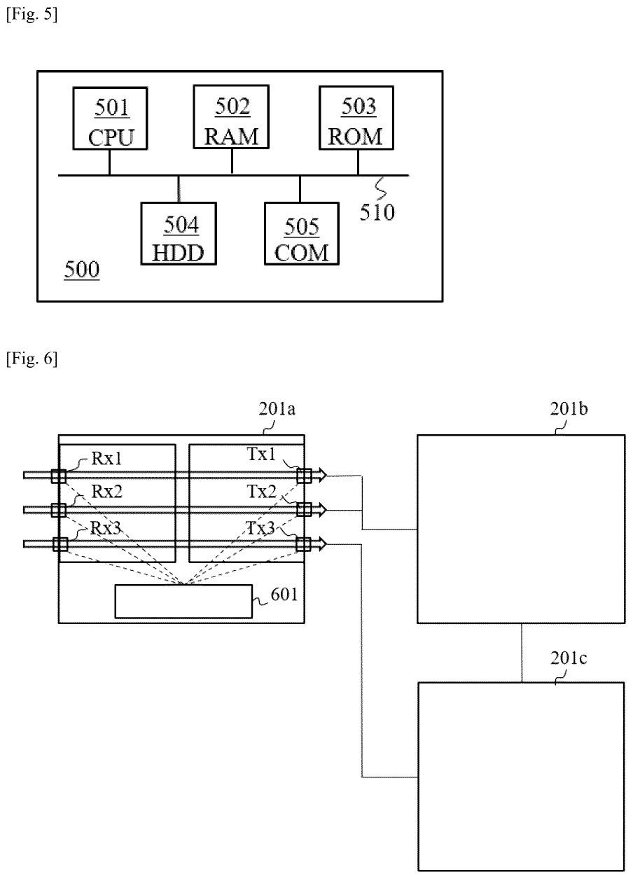

FIG. 6 illustrates schematically the communications network 101 and the monitoring system 102, in a second embodiment. The communications network 101 is identical to that in FIG. 2 and comprises the switches 201a, 201b and 201c. The monitoring system 102 differs from that in FIG. 2 in that the monitoring device (here referenced 601) is internal (rather than external) to the switch 201a. In this case, the monitoring device 601 monitors and only triggers actions on the switch 201a itself (it does not therefore act as a centralized function for several switches of the network).

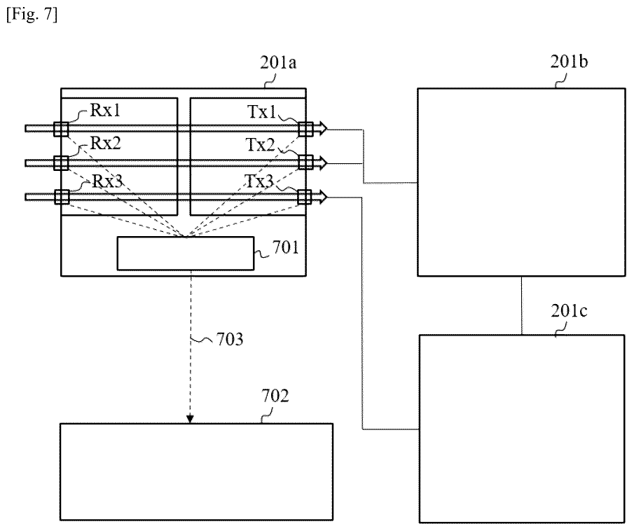

FIG. 7 illustrates schematically the communications network 101 and the monitoring system 102, in a third embodiment. The communications network 101 is identical to that in FIG. 2 and comprises the switches 201a, 201b and 201c. The monitoring system 102 differs from that in FIG. 2 in that the monitoring device comprises a first part 701 and a second part 702, respectively internal and external to the switch 201a, and connected together via a link 703. The two parts 701 and 702 are for example complementary (no redundancy): the first part 701 provides a first level of monitoring, for an immediate action on the switch 201a, and the second part 702 provides a second level of monitoring, for a wider vision and an action at the level of the network 101 (centralized function for several switches of the network).

1. A method for monitoring an onboard communications network of an aircraft, the communications network being a deterministic switched Ethernet network using virtual links and comprising a set of subscribers and a set of switches, the method being implemented by a monitoring system comprising an electronic circuitry, the method comprising, for a data stream transmitted or received by a given switch, a traffic policing function configured to make it comply with a bandwidth limit for the said data stream, the method further comprises, for the said data stream, a security function configured to make it comply with a reference profile of bandwidth consumption below the bandwidth limit, the security function comprising:
obtain measurements of at least one parameter of the said data stream;
as a function of the measurements obtained, calculate a value of at least one bandwidth consumption parameter, the calculated value participating in a definition of a measured profile of bandwidth consumption;
compare the measured profile with the reference profile, by comparing the calculated value of the at least one bandwidth consumption parameter with a reference value defined in the reference profile; and
in the case of verification of at least one difference criterion identified by the comparison, this difference criterion corresponding to the detection of an unusual behaviour which may constitute a malicious act, perform at least one act for safeguarding the communications network in such a manner as to allow it to counter attacks generated by sending a data stream remaining below the bandwidth limit.

2. The method according to claim 1, in which the at least one parameter of the data stream, for which measurements are obtained, belongs to the group comprising:
an average number of frames per second;
an average number of bytes per second;
a minimum data rate of the data stream;
a maximum data rate of the data stream; and
an average data rate of the data stream.

3. The method according to claim 1, in which the at least one bandwidth consumption parameter belongs to the group comprising:
at least one parameter relating to an envelope of the data stream; and
at least one parameter relating to a periodicity of the data stream.

4. The method according to claim 1, in which the at least one difference criterion belongs to the group comprising:
an overconsumption peak, defined by a number of frames or of bytes of the data stream, received or transmitted over a first time period, which is higher than a first high reference value;
a persistent overconsumption, defined by a number of frames or of bytes of the data stream, received or transmitted over a second time period longer than the first time period, which is higher than a second high reference value;
an under-consumption peak, defined by a number of frames or of bytes of the data stream, received or transmitted over a third time period, which is lower than a first low reference value;
a persistent under-consumption, defined by a number of frames or of bytes of the data stream, received or transmitted over a fourth time period longer than the third time period, which is lower than a second low reference value;
an average data rate of the data stream which is higher than an average reference data rate; and
a model of the data stream which has at least one difference with a reference model, the model of the data stream being obtained by applying, at times of transmission or of receipt of frames of the data stream, a mathematical time/frequency conversion function, the reference model being obtained by applying, at times of transmission or of receipt of frames of a standard data stream, the said mathematical function.

5. The method according to claim 1, in which the at least one safeguarding act belongs to the group comprising:
record a safeguarding event indicating the verification of the at least one difference criterion;
request the given switch to block a port of the given switch involved in transmitting or receiving the data stream;
request the given switch to block a virtual link involved in transmitting or receiving the data stream;
request the given switch to re-route the data stream in order to record it;
warn the subscribers of the communications network so that they refuse the data stream; and
reduce a priority assigned to the data stream.

6. The method according to claim 1, in which the data stream is transmitted or received by a given port of the given switch.

7. The method according to claim 1, in which the data stream is transmitted or received via a given virtual link going via a given port of the given switch.

8. (canceled)

9. A non-transitory storage medium, storing a computer programme comprising instructions leading to the execution, by a processor, of the method according to claim 1, when the said instructions are read and executed by the processor.

10. A system for monitoring an onboard communications network of an aircraft, the communications network being a deterministic switched Ethernet network using virtual links and comprising a set of subscribers and a set of switches, the monitoring system comprising an electronic circuitry configured for implementing, for a data stream transmitted or received by a given switch, a traffic policing function configured to make it comply with a bandwidth limit for the said data stream, the monitoring system wherein the electronic circuitry is furthermore configured for implementing, for the said data stream, a security function, configured to make it comply with a reference profile of bandwidth consumption below the bandwidth limit, the security function comprising:
obtain measurements of at least one parameter of the said data stream;
as a function of the measurements obtained, calculate a value of at least one bandwidth consumption parameter, the calculated value participating in a definition of a measured profile of bandwidth consumption;
compare the measured profile with the reference profile, by comparing the calculated value of the at least one bandwidth consumption parameter with a reference value defined in the reference profile; and
in the case of verification of at least one difference criterion identified by the comparison, this difference criterion corresponding to the detection of an unusual behaviour which may constitute a malicious act, perform at least one act for safeguarding the communications network in such a manner as to allow it to counter attacks generated by sending a data stream remaining below the bandwidth limit.

11. An aircraft comprising an onboard communications network which is a deterministic switched Ethernet network using virtual links and comprising a set of subscribers and a set of switches, the aircraft further comprises a monitoring system according to claim 10.
